(19) United States
(12) Patent Application Publication
(10) Pub. No.: US 2011/0087521 A1
(43) Pub. Date: Apr. 14, 2011

(54) Methodology For Setting, Prioritization, And Alignment Of Goals And Objectives Throughout Any Organization, At All Levels

(76) Inventors: ILEANA ROMAN STOICA, Hanover, MN (US); Sorin Roman Stoica, Hanover, MN (US)

(21) Appl. No.: 12/577,172

(22) Filed: Oct. 10, 2009

(51) Int. Cl. G06Q 10/00; G06Q 90/00

(52) U.S. Cl. 705/7.36; 705/7.38

(57) ABSTRACT

A methodology for setting, prioritization, and alignment of goals and objectives throughout an organization, which includes the following steps: identifying key goals for the organization as a whole, establishing each functional area's contribution to each said goals, establishing each functional area contributor's alignment and deliverables within the scope of each said goals, establishing key metrics and target levels for each said goal, followed by the repetition of the above steps at subordinated lower levels, as goals, metrics, and target levels are trickled down, to ensure alignment and goals assignment at all levels of the organization, from the top level role (i.e. CEO) to each entry level worker.

### BACKGROUND OF THE INVENTION

One of the most challenging tasks across an organization is to set, align, prioritize, and agree on goals and objectives. Despite a commonly encountered sense of urgency at every beginning of year, or with any strategic change in direction, leaders encounter a vast array of challenges on the path of gaining alignment and achieving teams' buy-in to various, sometimes conflicting, hard-to-prioritize goals and objectives.

These common challenges are encountered in the form of time consumption during goals setting exercises, maintaining alignment with key corporate goals at all levels, ensuring proper prioritization of these goals at team or individual level, followed by more time consumption when communicating results, delivering performance reviews, and/or paying bonuses.

### SUMMARY OF THE INVENTION

This methodology allows, through a straight-forward matrix system, the achievement of all these deliverables with minimal time consumption, no confusion or disputes around who does what, and, more important, perfect alignment in both direction and priority with key organizational goals. In itself, just this last item—perfect alignment with organizational goals—is a key driver of increased performance and business effectiveness. For ease of use and illustration, the methodology is best used in a matrix format—hence the working name of Goals and Objectives Matrix.

The goals and objectives setting, prioritization and alignment using this methodology is intended to take place as a working session at each level, following this sequence:
(a) identifying key goals for the organization as a whole,
(b) establishing each functional area's contribution to each said goals,
(c) establishing each functional area contributor's alignment and deliverables within the scope of each said goals,
(d) establishing key metrics and target levels for each said goal, together with milestones if applicable.

Then, steps (b) through (d) are to be repeated at subordinated lower levels, while maintaining alignment with the organizational goals identified in step (a). This way, goals, metrics, and target levels are trickled down, to ensure perfect alignment of goals and targets at all levels of the organization, from the top level role (i.e. CEO), to each entry level worker, and documentation of the results of all the steps listed above.

Using an example to illustrate how this methodology works, let's consider a company struggling to restore profitability as part of a turnaround action—hence its high focus on clearly defined, perfectly aligned and prioritized goals and objectives, with clear and speedy communication and quick buy-in at team and individual level.

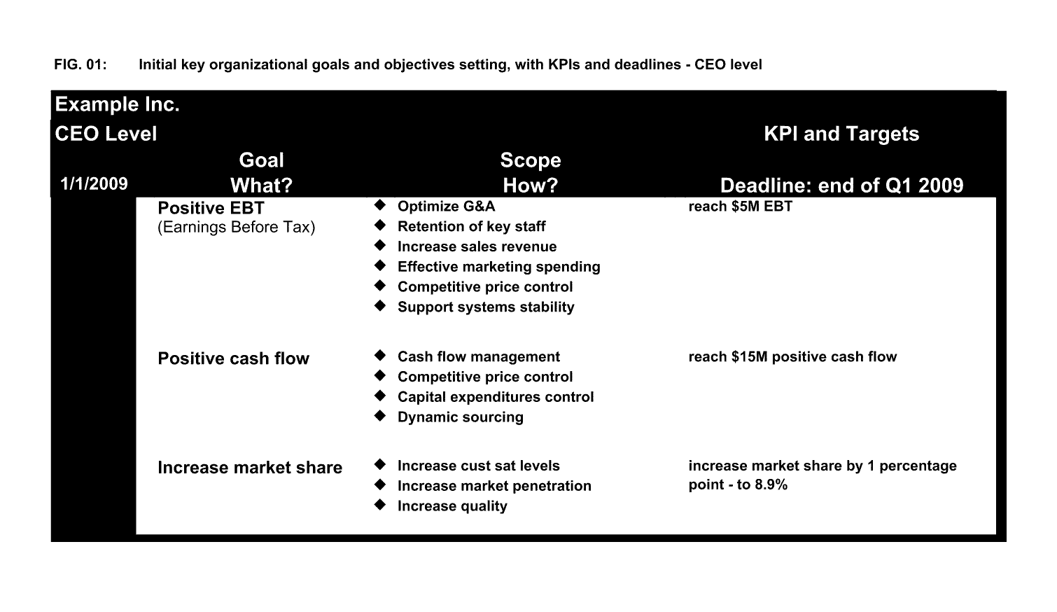

FIG. 01 shows how the methodology is applied by the company's CEO in a working session with the senior leadership team, to establish three key priorities for the company, positive EBT (earnings before tax), positive cash flow, and the increase of market share. During this exercise, deadline and target levels are established—thus defining success. Also during this working session, the scope of each deliverable and the “how to get there” are defined (i.e. to achieve positive EBT we need to increase sales revenue). These means of achieving the goals are listed under each respective goal.

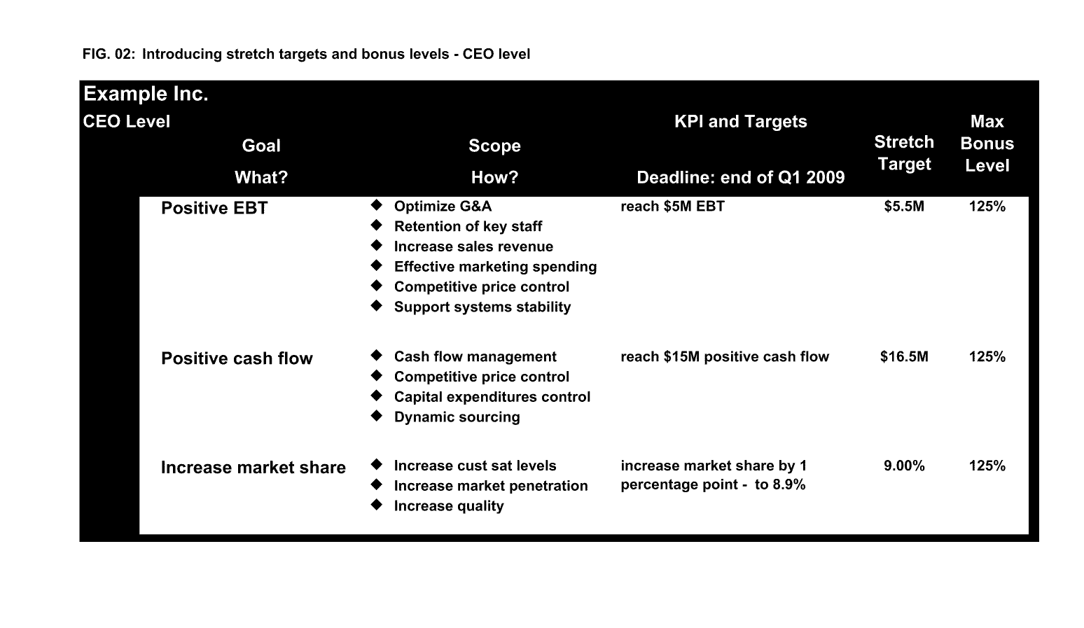

FIG. 02 introduces stretch target levels and maximum bonus payout levels for each goal. The methodology can also be successfully used in managing rewards and recognition of both individual and team contributors.

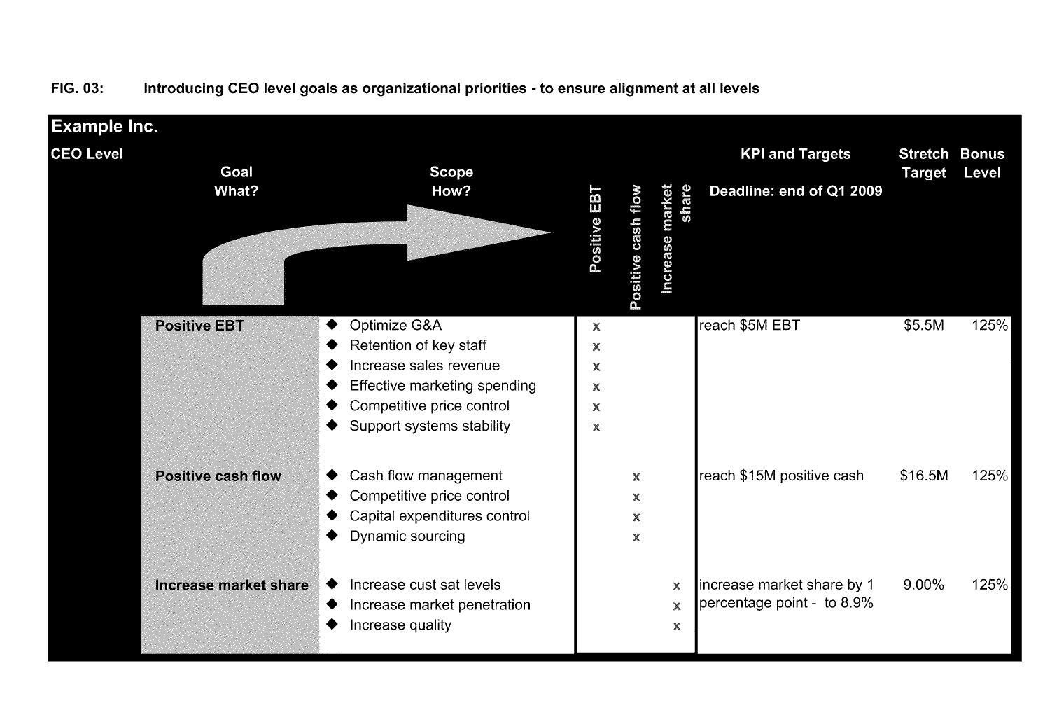

FIG. 03 illustrates how CEO level goals become indexes on the Goals and Objectives matrix, allowing the alignment of all subsequent goals established during team exercises, with CEO level goals.

CEO level goals (CEO+senior leadership team) are, in fact, the company's goals and objectives. Therefore, alignment—and synchronized prioritization—at all levels in the organization will ensure the focus and execution of corporate goals, as well as the ability, using this methodology, to make swift changes as dictated by evolving strategic priorities, or the economic environment. Following the arrows depicted in FIG. 03, the CEO goals now become indexes that will be reflected on all teams' Goals and Objectives Matrix worksheets. The “x” marks on respective columns, under the three indexes in our example, reflect the alignment with the respective index. Specifically, the action identified as “Optimize G&A” has an “x” reflecting its alignment to the goal named “Positive EBT (earnings before tax)”, as it is in direct support of this particular goal.

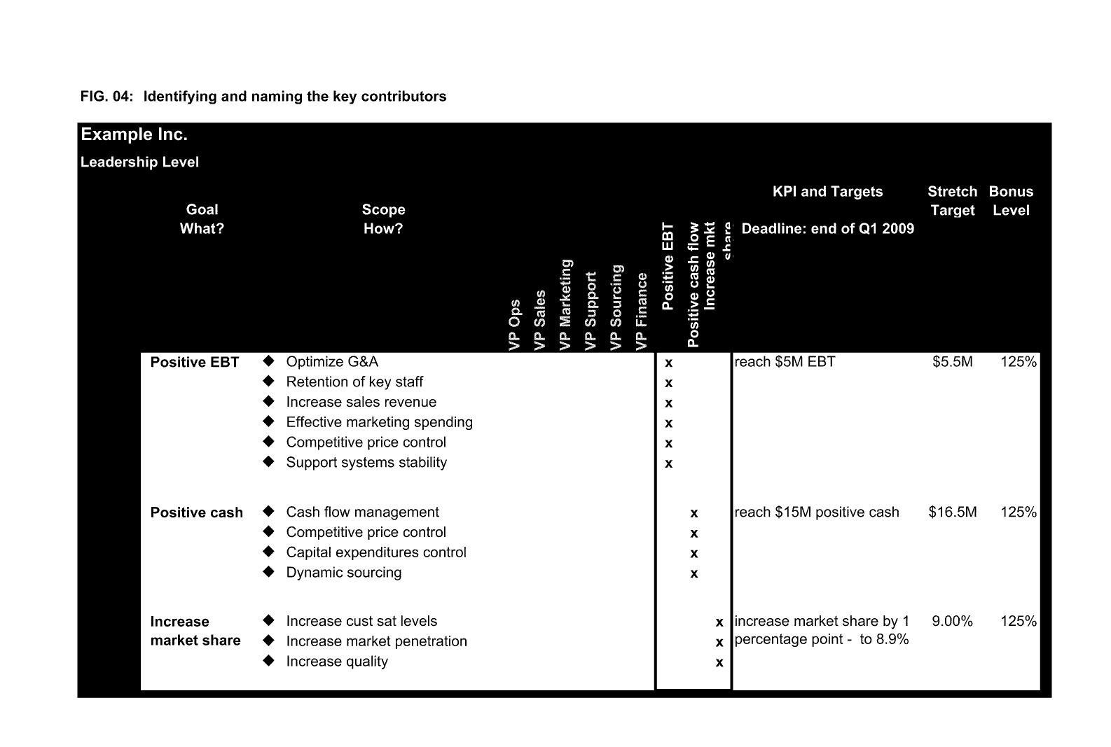

FIG. 04 identifies and names the key contributors in the team (yellow font); in this example, the key contributors in the CEOs team. As they are identified by function, at this level they are also department heads.

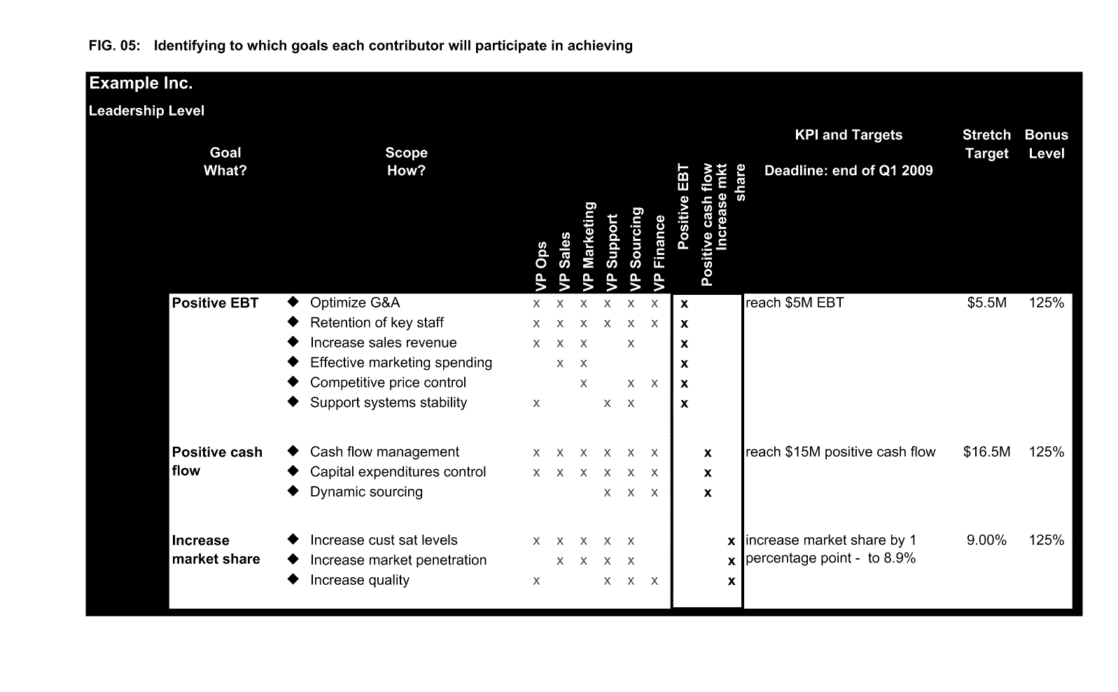

FIG. 05 reflects the results of the “how do we get there” working session for this team of contributors. With red “x” marks, the chart reflects individual contribution to each goal. For example, all contributors will work on the action named “Optimize G&A”, as they are all challenged to cut operating costs. However, only two of them are contributing to the action named “Effective marketing spending”: respectively, the VPs of Sales and Marketing. Therefore, this step clarifies individual contributions at the senior leadership team, with clear numeric targets, stretch targets, and bonus payouts.

In the example shown in FIG. 05, all bonus payouts at this level are identified at 125%. For example, if a contributor's bonus level is 20% of his/her income, having a goal marked for bonus level at 125% reflects the urgency and importance of the goal, as well as the fact that, if the stretch level is achieved, the contributor would stand to be paid 25% bonus (125% of his level). This is an important motivational and prioritization tool; in a later illustration we will show how, through assignment of different bonus levels, goals can get easily prioritized, thus maintaining clear focus and ensuring a particular order of execution.

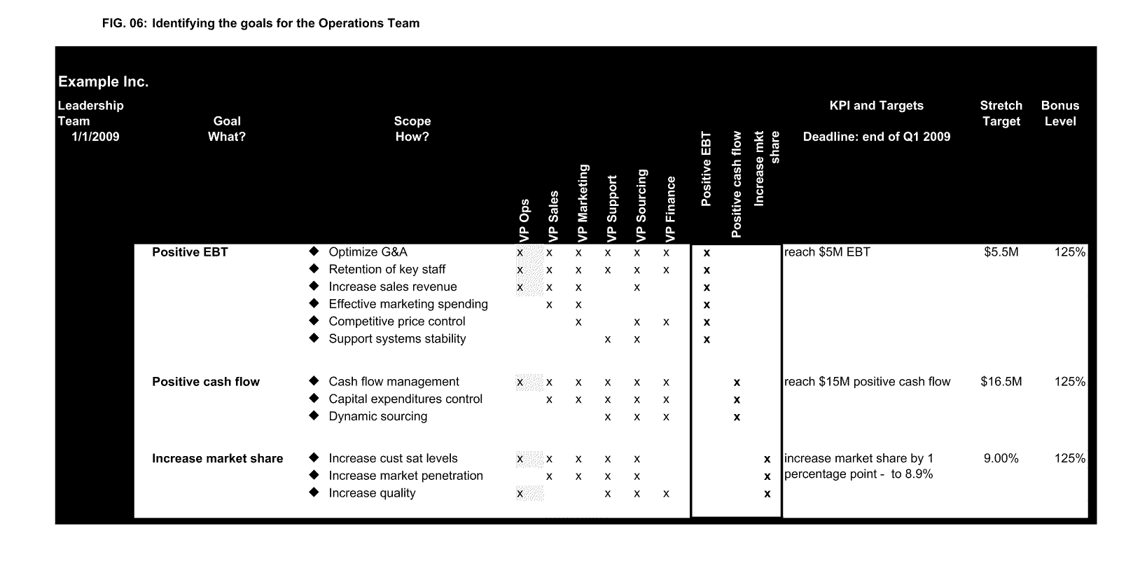

FIG. 06 illustrates which goals apply to the Operations Team and its leader, the VP of Operations. Highlighted in yellow are those specific goals to which the Operations Team will contribute.

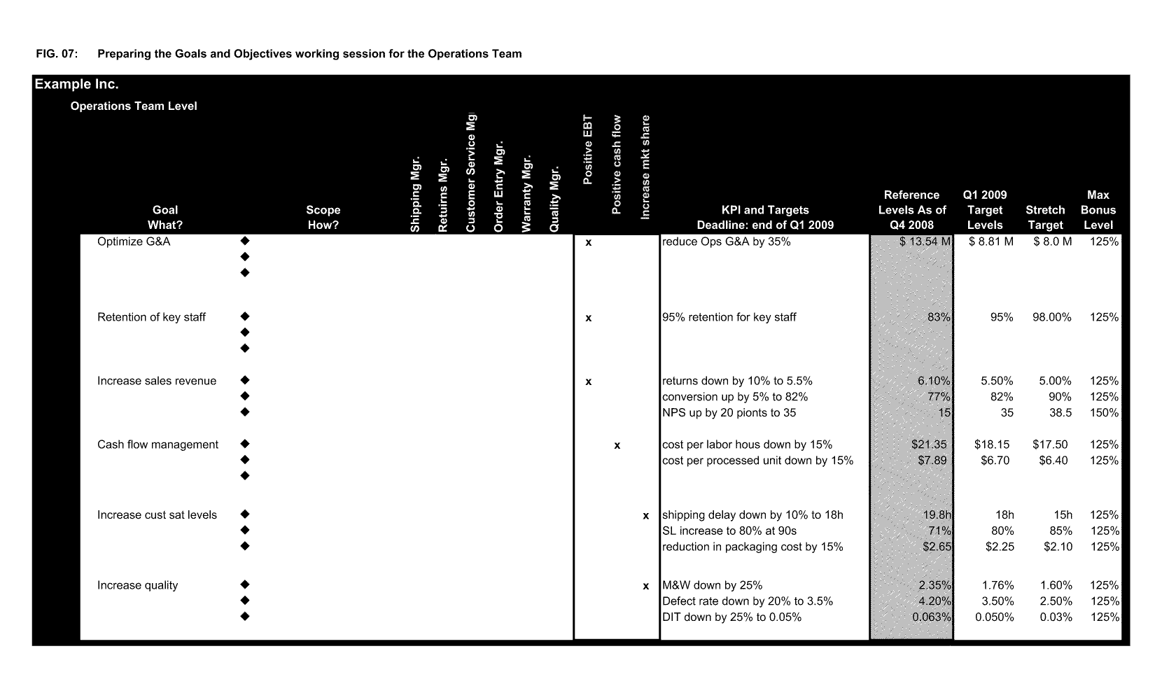

FIG. 07 prepares the worksheet for the Operations Team working session. The goals previously identified as deliverables for the Operations Team (FIG. 06), are now reflected as goals for the Operations Team. In yellow font, the corporate goals indexes are still present to ensure alignment. In grey highlight, baseline values for the key deliverables are illustrated, to avoid future confusion around metrics—how they were measured, etc. If needed, documentation of the methods used to measure these KPIs can be attached.

Target levels and stretch target levels are identified. Maximum bonus levels are stated—again, all equal to 125%. All these goals are of equal importance, in our example.

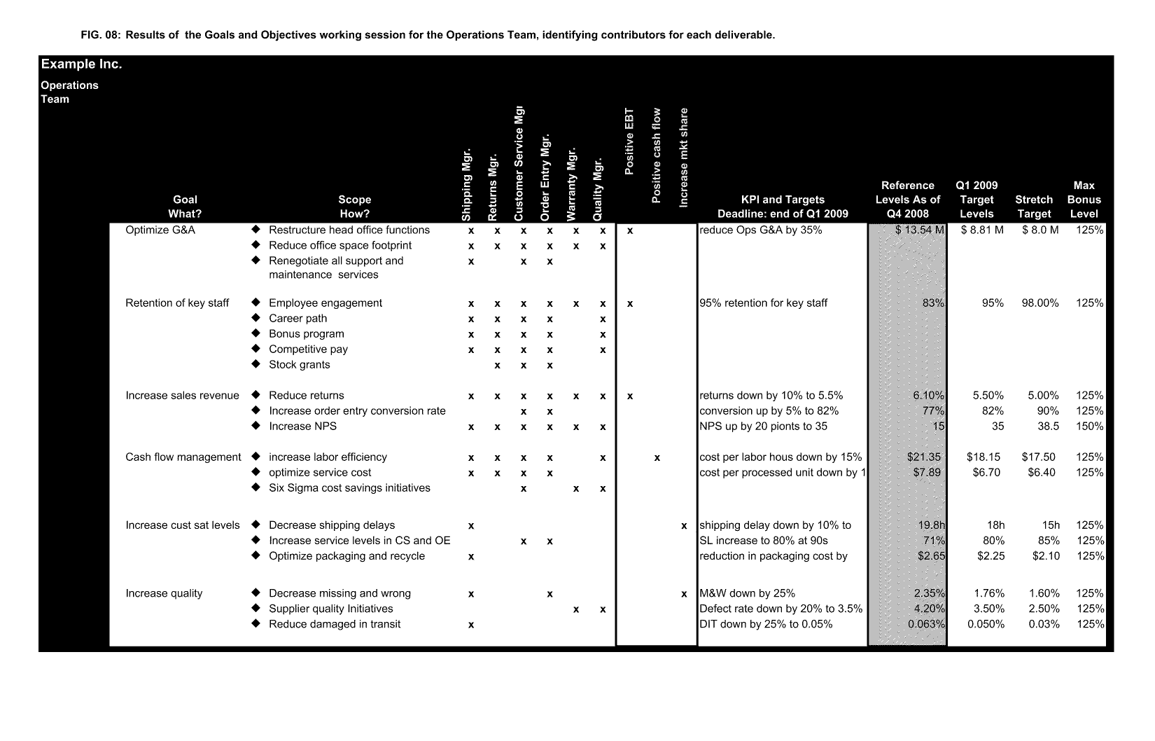

FIG. 08 illustrates the deliverables for each contributor at this team level. Through an identical process as reflected in paragraph [0011] and FIG. 05, each contributor signs up for goals, clearly aligned with corporate level goals through the yellow font indexes, and has clear visibility into targets, baseline levels of metrics and KPIS, and key actions to deliver on the goals (how to get there).

This exercise can be repeated down to individual contributors, by replicating the methodology reflected above.

1. A methodology for setting, prioritization, and alignment of goals and objectives throughout an organization, which includes the following steps: (a) identifying key goals for the organization as a whole, (b) establishing each functional area's contribution to each said goals, (c) establishing each functional area contributor's alignment and deliverables within the scope of each said goals, (d) establishing key metrics and target levels for each said goal, followed by the repetition of steps (b) through (d) at subordinated lower levels, while maintaining alignment with the organizational goals identified in step (a), as goals, metrics, and target levels are trickled down, to ensure perfect alignment of goals and targets at all levels of the organization, from the top level role (i.e. CEO), to each entry level worker, and documentation of the results of all the steps listed above.

2. The methodology of claim 1, wherein the business goals can be achieved in a sequential or simultaneous manner.

3. The methodology of claim 1, wherein the goals are established for a single or multi-unit business, regardless of the type of business.

4. The methodology of claim 1, wherein the business goals can have different weights.

5. The methodology of claim 1, wherein the target levels established, in conjunction with the results achieved, are used as basis for a bonus or rewards program, or any other form of variable, performance-driven compensation, whether in part or in whole.

6. The methodology of claim 1, wherein the target levels established, in conjunction with the results achieved, are used to manage individual or team performance.

7. The methodology of claim 1, wherein the business goals are of a creative nature—i.e. design, research and development, software development, artistic work.

8. The methodology of claim 1, wherein the respective business goals are individual milestones on the path to a larger, more complex goal or deliverable.

9. The methodology of claim 1, wherein the target levels established and subsequent functional areas' contribution to said goals are used for human resource management and/or resource allocation.

10. The methodology of claim 1, wherein some of the business units contributing to the achievement of one or more goals are automated production lines or automated systems, or any combination between human and technology contributors.

11. The methodology of claim 1, wherein the key goal(s) are established, aligned and prioritized throughout an organization in support of a strategic development plan (i.e. expansion of a business overseas).

12. The methodology of claim 1, wherein the key goal(s) are established, aligned and prioritized throughout an organization in support of a plan targeting an individual (i.e. treatment plan for a complex trauma patient).

13. A computerized application for the implementation, documentation, management, and tracking of goals and objectives using a methodology for setting, prioritization, and alignment of goals and objectives throughout an organization, which includes the following steps: (a) identifying key goals for the organization as a whole, (b) establishing each functional area's contribution to each said goals, (c) establishing each functional area contributor's alignment and deliverables within the scope of each said goals, (d) establishing key metrics and target levels for each said goal, followed by the repetition of steps (b) through (d) at subordinated lower levels, while maintaining alignment with the organizational goals identified in step (a), as goals, metrics, and target levels are trickled down, to ensure perfect alignment of goals and targets at all levels of the organization, from the top level role (i.e. CEO), to each entry level worker, and documentation of the results of all the steps listed above.

14. The methodology of claim 13, wherein the said computerized application is used in conjunction with an application for the management of organizational charts.

15. The methodology of claim 13, wherein the said computerized application is used in conjunction with an application for the management of human resources.

16. The methodology of claim 13, wherein the said computerized application is used in conjunction with an application for the management of payroll, bonus payouts, and/or pay-for-performance payouts (i.e. commission pay, per-unit pay).

17. The methodology of claim 13, wherein the said computerized application is used for specific sections of the organization.
